(19) United States
(12) Patent Application Publication
(10) Pub. No.: US 2006/0259719 A1
(43) Pub. Date: Nov. 16, 2006

(54) Control terminal

(75) Inventors: Kenichi Hirano, Kyoto (JP); Masakazu Urade, Kyoto (JP); Mitsuya Nakahara, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/432,628

(22) Filed: May 12, 2006

(30) Foreign Application Priority Data
May 12, 2005 (JP) 2005-139190

(51) Int. Cl. G06F 13/00; G06F 12/00

(52) U.S. Cl. 711/159; 711/170

(57) ABSTRACT

A control terminal is provided which is capable of improving a usage efficiency of a main memory means. An elapsed time measuring unit measures an elapsed time (unused time) since a control program of a device stored in the a main memory (main memory means) has been lastly used in a computer (control terminal). Then, the computer automatically unloads a control program having an elapsed time equal to or greater than a predetermined threshold value from the main memory.

### BACKGROUND OF THE INVENTION

1. Field of the Invention

The present invention relates to a control terminal which is connectable with a plurality of devices (peripheral devices) and controls the connected devices by executing a device control program.

2. Description of the Related Art

In computers (control terminals), programs are loaded in a main memory and are executed by a CPU (central processing unit). Due to limited memory capacity of the main memory, when a plurality of programs is loaded in the main memory, such main memory management is required as to load only a necessary program in the main memory.

Effective main memory management methods without having to use a complex management tool have been proposed. For example, Japanese Unexamined Patent Application Publication No. 1-223534 has proposed a memory management method in which a computer includes a tool that checks a free space in a main memory when a program is loaded on the main memory, and stores only a program that is storable in the main memory according to the check result.

In the conventional main memory management method, the storable program is loaded in the free space of the main memory. For this reason, in the conventional main memory management method, when a program for controlling a device detachable from the computer is loaded in the main memory, and the size of the program to be loaded is greater than the free space of the main memory, the program cannot be loaded, thereby disabling the use of the device.

In a general computer, a program for controlling a device which has not been used for a long time after being detached from the computer, that is, a less frequently used device, is also stored in a main memory. In this case, memory capacity of the main memory is additionally wasted due to the program of controlling the less frequently used device. Therefore, in the general computer, when a control program is firstly loaded in order to connect a new device to the computer, and in this case if the free space of the main memory is less than an amount of data of the control program of the new device, the new device cannot be used.

### SUMMARY OF THE INVENTION

Accordingly, it is an object of the present invention to provide a control terminal which permits a sufficient free space in a main memory and improves a usage efficiency of the main memory.

In order to achieve the object of the present invention, the control terminal of the present invention measures an elapsed time (unused time) since a control program of a device (peripheral device) stored in the main memory (main memory means) has been lastly used in a computer (control terminal) and an amount of data stored in the main memory (memory usage), and unloads the control program from the main memory according to values measured above.

According to an aspect of the present invention, there is provided a control terminal comprising a connector connectable with at least one peripheral device and a main memory for storing therein a control program for the peripheral device connected to the connector, the control program stored in the main memory being used to control the peripheral device, wherein the control terminal further comprises an unused time measuring unit for measuring an unused time of each control program stored in the main memory, a data amount measuring unit for measuring an amount of data stored in the main memory, a threshold value setting unit for setting a threshold value for the unused times of the control programs and a threshold value for the amount of data stored in the main memory, a determining unit for determining one of a control program to be loaded in the main memory and a control program to be unloaded from the main memory, according to a result of comparison between one of the unused time measured by the unused time measuring unit and the amount of data measured by the data amount measuring unit and the corresponding threshold value set by the threshold value setting unit, a loading unit for loading the control program to the main memory according to the determination result of the determining unit, and an unloading unit for unloading the control program from the main memory according to the determination result of the determining unit.

In the aforementioned aspect of the present invention, the determining unit may compare the unused time measured by the unused time measuring unit with the threshold value for the unused time set by the threshold value setting unit, and may determine to unload a control program having an unused time equal to or greater than the threshold value or a control program having an unused time exceeding the threshold value.

In addition, the determining unit may determine to unload a control program for each predetermined monitoring time interval.

In addition, the control terminal may further comprise a device detecting unit which detects connection of the peripheral devices, wherein when the device detecting unit detects that a peripheral device controlled by using the control program having an unused time equal to or greater than the threshold value or the control program having an unused time exceeding the threshold value is connected with the connection means, the determining unit does not determine to unload a corresponding control program, whereas when the device detecting unit detects that the peripheral device is separated therefrom, the determining unit determines to unload the corresponding program.

In addition, the threshold setting unit may set an upper limit value as a threshold value for the amount of data stored in the main memory, and the determining unit may compare the amount of data measured by the data amount measuring unit with the upper limit value determined by the threshold value setting unit, and may repeatedly determine to unload the control program having a longest unused time measured by the unused time measuring unit until the amount of data becomes equal to or less than the upper limit value, or until the sum of the amount of data becomes less than the upper limit value.

In addition, the control terminal may further comprise a device detecting unit which detects connection of the peripheral devices, wherein, if a control program of the peripheral device of which connection is detected by the detecting unit is unloaded by the unloading unit, the determining unit compares a amount of data, which is obtained by adding a amount of data of the control program of the peripheral device and a amount of data measured by the data amount measuring unit, with the upper limit value determined by the threshold value setting unit, and repeatedly determines to unload a control program having a longest unused time measured by the unused time measuring unit until the sum of the amount of data becomes equal to or less than the upper limit value, or until the sum of the amount of data becomes less than the upper limit value, and if the sum of the amount of data becomes equal to or less than the upper limit value, or the sum of the amount of data becomes less than the upper limit value, the determining unit determines to load the control program of the peripheral device of which connection is detected.

In addition, the control terminal may further comprise an unloaded program information storing unit which stores identification information on the control program unloaded by the unloading unit in a specific memory area, so that a last unloaded control program can be determined, wherein the threshold setting unit sets a lower limit value as a threshold value for the amount of data stored in the main memory, and the determining unit compares the amount of data measured by the data amount measuring unit with the lower limit value determined by the threshold value setting unit, and loads the last unloaded control program based on information stored by the unloaded program information storing unit until the amount of data becomes equal to or greater than the lower limit value, or until the sum of the amount of data is excessive of the lower limit value.

Accordingly, in the present invention, an elapsed time (unused time) since a control program of a peripheral device stored in the main memory has been lastly used in a control terminal and an amount of data stored in the main memory are measured, and according to values measured above, the control program is unloaded from the main memory. Therefore, the main memory can have a sufficient free space, thereby improving a usage efficiency of the main memory.

In addition, according to the present invention, a control program that has an elapsed time (unused time) since it has been lastly used in the control terminal equal to or greater than a threshold value, or exceeding the threshold value, can be unloaded, thereby improving a usage efficiency of the main memory.

In addition, according to the present invention, when an amount of data stored in the main memory becomes equal to or greater than the threshold value, or exceeding the threshold value, a program that has a longest elapsed time (unused time) since it has been lastly used in the control terminal can be unloaded. In other words, a memory area of the main memory can be available by using an LRU (least recently used) algorithm, thereby improving a usage efficiency of the main memory.

Therefore, since a control program of a less frequently used peripheral device can be unloaded, a memory capacity of the main memory is not additionally wasted to store the program, thereby providing a sufficient free space in the main memory. As a result, such a problem that a peripheral device cannot be used when it is connected to the control terminal can be avoided.

In addition, according to the present invention, an unloaded control program can be reloaded according to an amount of data stored in the main memory. Therefore, when a user reconnects a peripheral device, a probability increases that a corresponding control program is stored in the main memory, and thus a loading time required for starting to use the device can be saved.

In addition, according to the present invention, an unloading process of a control program of a less frequently used peripheral device or a reloading process of an unloaded control program can be automatically performed, thereby improving a usage efficiency of the main memory without a user's awareness.

### BRIEF DESCRIPTION OF THE DRAWINGS

FIG. 1 shows a system configuration according to an embodiment of the present invention;

FIG. 2 is a block diagram showing functions of a computer according to the embodiment of the present invention;

FIG. 3 shows an example of elapsed time information according to the embodiment of the present invention;

FIG. 4 shows an example of memory usage information according to the embodiment of the present invention;

FIG. 5 shows an example of monitoring time interval information according to the embodiment of the present invention;

FIG. 6 shows an example of threshold value information according to the embodiment of the present invention;

FIG. 7 shows an example of unloaded program information according to the embodiment of the present invention;

FIG. 8 is a flowchart (comparison between an elapsed time and a time threshold value) illustrating an operation of a computer according to the embodiment of the present invention;

FIG. 9 is a flowchart (comparison between a memory usage and a maximum memory threshold value) illustrating an operation of a computer according to the embodiment of the present invention;

FIG. 10 is a flowchart (comparison between a memory usage and a minimum memory threshold value) illustrating an operation of a computer according to the embodiment of the present invention; and

FIG. 11 is a flowchart (comparison between a sum of memory usage and amount of data of a desired control program and a maximum memory threshold value) illustrating an operation of a computer according to the embodiment of the present invention.

### DESCRIPTION OF THE PREFERRED EMBODIMENTS

Hereinafter, a control terminal according to an embodiment of the present invention will be described in detail with reference to accompanying drawings.

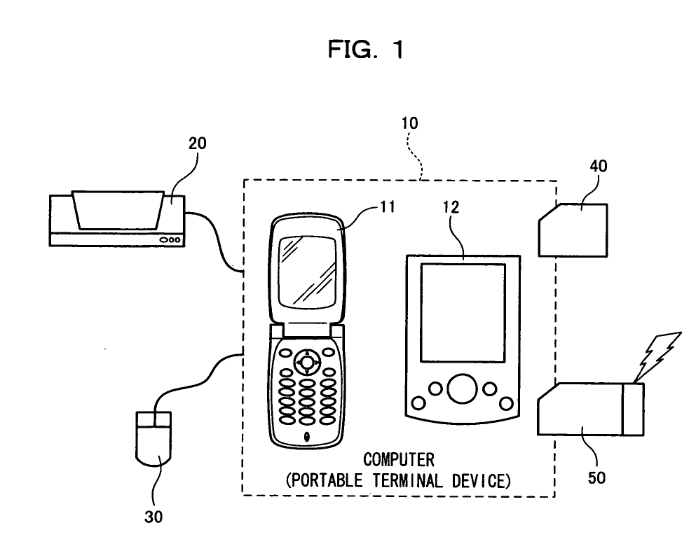

FIG. 1 shows a system configuration according to an embodiment of the present invention.

Referring to FIG. 1, reference numeral 10 indicates a computer, that is, a control terminal. The computer may be a cell phone 11 or a PDA (personal digital assistance) 12.

A device (peripheral device) connectable to the computer 10 may be a printer 20 or a mouse 30 in accordance with the USB (universal serial bus) standard. Further, the device connectable to the computer 10 may be a flash memory card 40 or a wireless-module card 50 in accordance with the SD (secure digital) standard.

As described above, the computer 10 can be connected with a plurality of devices through an interface (connection means, not shown), and each of the devices can be controlled by its device control program. The devices can be connected to or separated from the computer 10 while the computer 10 operates.

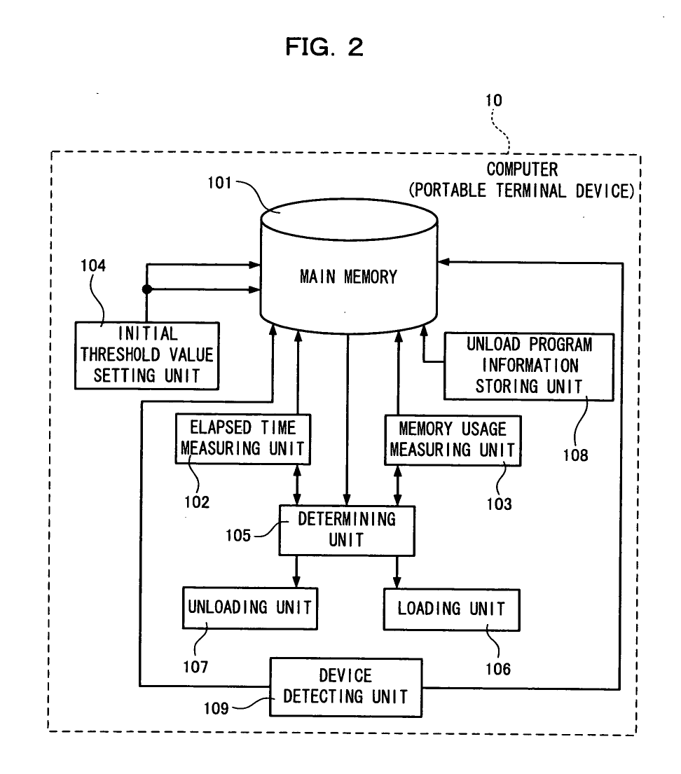

FIG. 2 is a block diagram of the computer 10.

In FIG. 2, a main memory 101 is a main memory means. The main memory 101 stores device control programs of each device connected to the computer 10. In addition, the main memory 101 stores elapsed time information T1, memory usage information T2, monitoring time interval information T3, threshold value information T4, and unloaded program information T5, which will be described later.

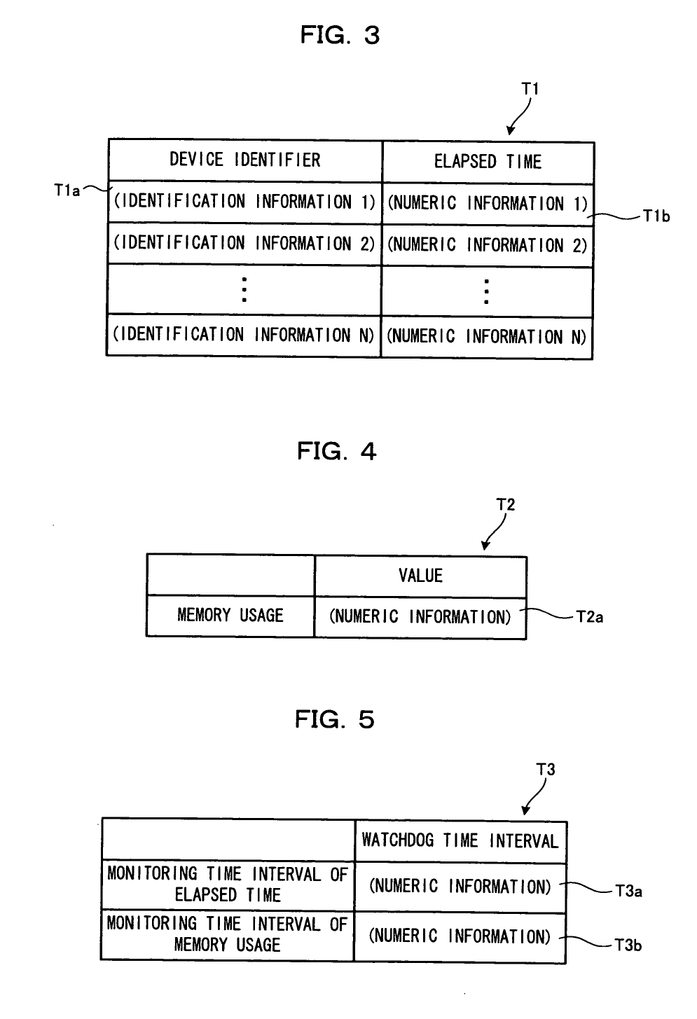

The elapsed time information T1 indicates an elapsed time since a device control program stored in the main memory 101 has not been used in the computer 10. FIG. 3 shows an example of the elapsed time information T1. As shown in FIG. 3, the elapsed time information T1 includes identifier information (identification information) on each device T1a and numeric information T1b on an elapsed time (unused time) since the device control program has not been used in the computer 10. If the number of devices connected to the computer 10 increases, the identification information T1a and the numeric information T1b are queued with a suffix of 1, 2, . . . , N in the field of the elapsed time information T1.

The memory usage information T2 indicates an amount of data stored in the main memory 101 (memory usage). FIG. 4 shows an example of the memory usage information T2. As shown in FIG. 4, the memory usage information T2 may include numeric information T2a on memory usage.

The monitoring time interval information T3 indicates a monitoring time interval by which an unused time of a device control program is watched (monitoring time interval of elapsed time) and a monitoring time interval by which a memory usage is watched (monitoring time interval of memory usage). FIG. 5 shows an example of the monitoring time interval information T3. As shown in FIG. 5, the monitoring time interval information T3 may include numeric information T3a of the monitoring time interval of elapsed time and numeric information T3b of the monitoring time interval of memory usage.

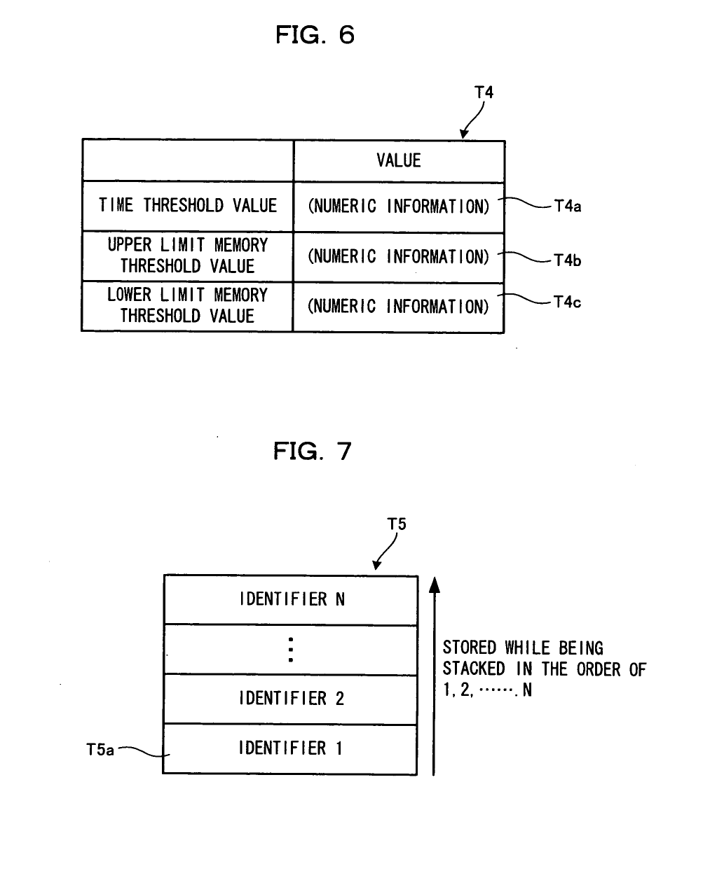

The threshold value information T4 indicates a threshold value for an unused time of the control program and a threshold value for the amount of data stored in the main memory 101 (memory usage). FIG. 6 shows an example of the threshold value information T4. As shown in FIG. 6, the threshold value information T4 may include numeric information T4a on a time threshold value, that is, a threshold value for the unused time of the control program, and numeric information T4b on a maximum memory threshold value and numeric information T4c on a minimum memory threshold value.

The unloaded program information T5 indicates an unloaded control program, and is constructed so as to determine a last unloaded control program. FIG. 7 shows an example of the unloaded program information T5. As shown in FIG. 7, the unloaded program information T5 includes identifier information (identification information) T5a of an unloaded control program and is stacked in the order of unloading. Therefore, a last stored identifier N becomes an identifier of a recently unloaded control program (last unloaded control program).

Reference numeral 102 indicates an elapsed time measuring unit that is an unused time measuring means. The elapsed time measuring unit 102 respectively measures elapsed times (unused times) since control programs have not been used in the computer 10, and creates the elapsed time information T1.

Reference numeral 103 indicates a memory usage measuring unit that is a data amount measuring means. The memory usage measuring unit 103 measures the amount of data (memory usage) stored in the main memory 101, and creates the memory usage information T2.

Reference numeral 104 indicates an initial threshold value setting unit that is a threshold value setting means. The initial threshold value setting unit 104 sets a monitoring time interval for an unused time of a control program (numeric information T3a on the monitoring time interval of elapsed time) and a monitoring time interval for a memory usage (numeric information T3b on the monitoring time interval of memory usage), and creates the monitoring time interval information T3.

In addition, the initial threshold value setting unit 104 sets a threshold value for an unused time of the control program (numeric information T4a on a time threshold value) and a threshold value for a memory usage (numeric information T4b of maximum memory threshold value and numeric information T4c of minimum memory threshold value), and creates the threshold value information T4.

Reference numeral 105 indicates a determining unit. According to a result obtained by comparing the elapsed time (unused time) measured by the elapsed time measuring unit 102 and the memory usage measured by the memory usage measuring unit 103 with the threshold value set by the initial threshold value setting unit 104, the determining unit 105 determines a control program to be loaded in the main memory 101 and a control program to be unloaded from the main memory 101.

Reference numeral 106 indicates a loading unit. Based on the result determined by the determining unit 105, the loading unit 106 loads the control program to the main memory 101.

Reference numeral 107 indicates an unloading unit. Based on the result determined by the determining unit 105, the unloading unit 107 unloads the control program from the main memory 101.

Reference numeral 108 indicates an unloaded program information storing unit. The unloaded program information storing unit 108 stores identification information on the control program unloaded by the unloading unit 107 in a specific memory area of the main memory 101, so that the last unloaded control program can be determined, thereby creating the unloaded program information T5. Specifically, the unloaded program information storing unit 108 stacks identifiers of unloaded control programs in the order of unloading.

Reference numeral 109 indicates a device detecting unit. The device detecting unit 109 detects connection of devices.

After the determining unit 105 determines a control program that is loaded or unloaded by the determining unit 105 according to the elapsed time information T1, the memory usage information T2, and the threshold value information T4, the computer 10 loads or unloads a corresponding control program by the loading unit 106 or the unloading unit 107. When unloading, the computer 10 stores information on a control program to be unloaded in a specific memory area.

Now, the operation of the computer 10 will be described in detail.

First, the process of unloading a control program will be described, when an elapsed time (unused time) since the control program has not been used in the computer 10 is equal to or greater than the time threshold value, or the elapsed time is in excess of the time threshold value.

The computer 10 determines whether the numeric information T4a on the time threshold value is greater or less than the numeric information T1b on an elapsed time (unused time) since devices such as the printer 20, the mouse 30, the flash memory card 40, and the wireless-module card 50 have stopped their operations in the computer 10. Thereafter, the computer 10 unloads the control program according to the determination result.

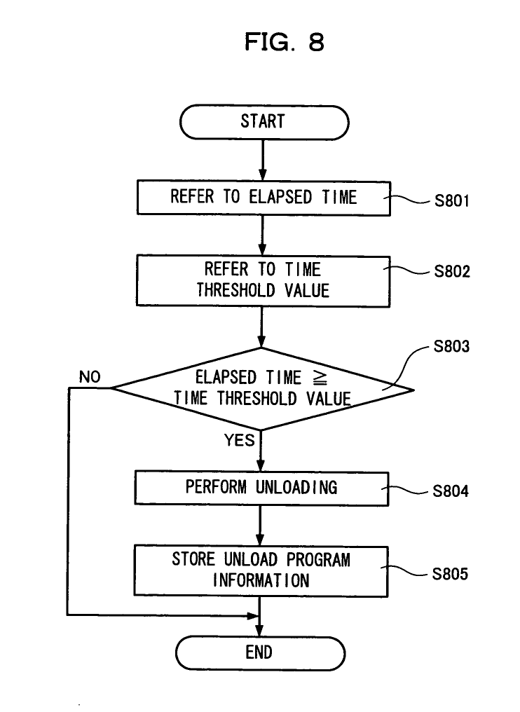

The computer 10 may carry out processes shown in the flowchart of FIG. 8.

Here, the computer 10 performs steps in the flowchart of FIG. 8 with respect to all numeric information T3a of monitoring time interval of elapsed time.

First, the determining unit 105 refers to the elapsed time information T1 (step S801), refers to the numeric information T4a on a time threshold value from the threshold value information T4 (step S802), compares the numeric information T1b of elapsed time with the numeric information T4a on the time threshold value (step S803), and determines to unload a device control program having an elapsed time equal to or greater than the time threshold value (elapsed time≧time threshold value). If all elapsed times are less than the time threshold value (elapsed time<time threshold value), the computer 10 ends the processes of the present flowchart instead of determining an unloading process to be performed by the determining unit 105.

Next, the unload unit 107 performs unloading of the control program determined to be unloaded by the determining unit 105 (step S804). When the unloading of the control program is performed, the unloaded program information storing unit 108 stacks the identifier of the control program into a specific memory area of the main memory 101 (step S805), thereby ending the processes of the present flowchart.

When the device detection unit 109 detects that the device having an elapsed time equal to or greater than the time threshold value (elapsed time≧time threshold value) is connected to the computer 10, the computer 10 cannot use the device if the control program is unloaded. In this case, therefore, the determining unit 105 determines to perform unloading not at that moment but right after the device detecting unit 109 detects that a corresponding device is separated.

Although it has been described that the control program satisfying the condition of “elapsed time≧time threshold value” is unloaded, a control program satisfying the condition of “elapsed time>time threshold value” may be unloaded.

Through the aforementioned processes, a memory area, which stores a device control program that has not been used for long since it is separated from the computer (a control program having a least probability to be used later), can be automatically available, thereby improving usage efficiency of the main memory.

For example, if an elapsed time since the flash memory card 40 has been separated from the computer 10 becomes equal to or greater than the time threshold value, the computer 10 automatically unloads a control program of the flash memory card 40. Therefore, deterioration of the usage efficiency of the main memory 101 can be solved since the control program of the flash memory card 40 is stored in the main memory 101, and thus the computer 10 can improve the usage efficiency of the main memory 101.

Next, the process to be performed when the memory usage becomes equal to or greater than the maximum memory threshold value, or when the memory usage becomes in excess of the maximum memory threshold value will be described.

The computer 10 determines whether the numeric information T2a of the memory usage is greater or less than the numeric information T4b of the maximum memory threshold value. Then, according to the determination result, the computer 10 refers to the elapsed time information T1 and unloads a control program having a longest elapsed time.

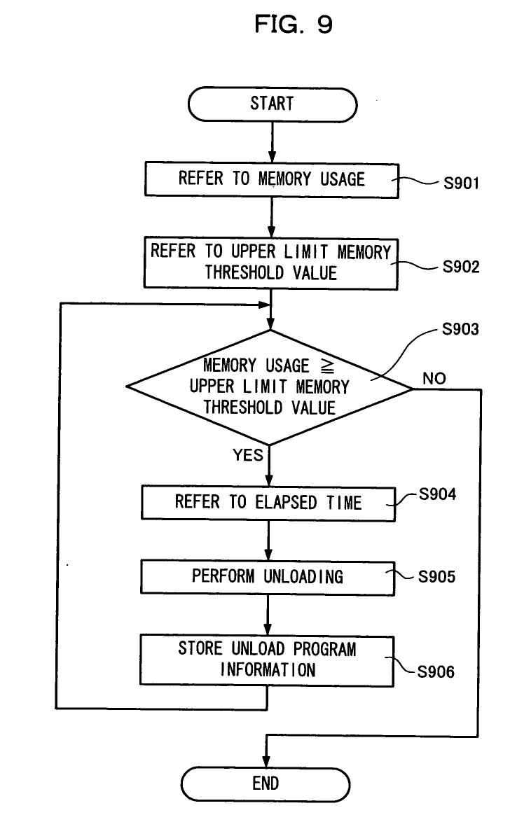

The computer 10 may carry out processes of the flowchart of FIG. 9.

Here, the computer 10 performs steps in the flowchart of FIG. 9 with respect to all numeric information T3b of monitoring time interval of memory usage.

First, the determining unit 105 refers to the numeric information T2a of memory usage from the memory usage information T2 (step S901), refers to the numeric information T4b on the maximum memory threshold value from the threshold value information T4 (step S902), compares the numeric information T2a of memory usage with the numeric information T4b on the maximum memory threshold value (step S903), refers to the elapsed time information T1 if the memory usage becomes equal to or greater than the maximum memory threshold value (memory usage≧maximum memory threshold value) (step S904), and determines to unload a device control program of which numerical information T1b of elapsed time is the greatest. Meanwhile, in the first step S903, if the memory usage becomes less than the maximum memory threshold value (memory usage<maximum memory threshold value), the computer 10 ends the processes of the present flowchart instead of determining an unloading process to be performed by the determining unit 105.

Next, the unload unit 107 performs unloading of the control program determined to be unloaded by the determining unit 105 (step S905). When the unloading of the control program is performed, the unloaded program information storing unit 108 stacks the identifier of the control program into a specific memory area of the main memory 101 (step S906).

Next, returning to step S903, until the memory usage becomes less than the maximum memory threshold value (memory usage<maximum memory threshold value), the computer 10 repeats the aforementioned processes (steps S903 to S906), thereby ending the processes of the present flowchart.

Although it has been described that the control program satisfying the condition of “memory usage≧maximum memory threshold value” is unloaded, a control program satisfying the condition of “memory usage>maximum memory threshold value” may be unloaded.

Through the aforementioned processes, for example, if a memory usage of the main memory is restricted due to an application program execution, obstruction caused by the application program execution can be avoided by unloading a control program having a longest unused time among control programs loaded at that moment (a control program having a least probability to be used later), thereby improving usage efficiency of the main memory.

Next, the process to be performed when the memory usage becomes equal to or less than the minimum memory threshold value, or when the memory usage becomes less than the minimum memory threshold value will be described.

The computer 10 determines whether the numeric information T2a of the memory usage is greater or less than the numeric information T4c of the minimum memory threshold value. Then, according to the determination result, the computer 10 refers to the unloaded program information T5 and loads a control program of an identifier stacked in a highest position (a last unloaded control program).

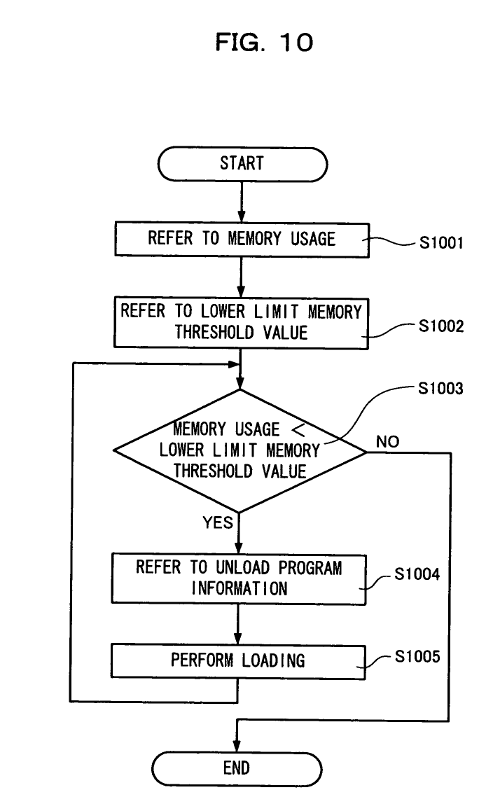

The computer 10 may carry out processes shown in the flowchart of FIG. 10.

Here, the computer 10 performs steps in the flowchart of FIG. 10 with respect to all numeric information T3b of monitoring time interval of memory usage.

First, the determining unit 105 refers to the numeric information T2a of memory usage from the memory usage information T2 (step S1001), refers to the numeric information T4c on the minimum memory threshold value from the threshold value information T4 (step S1002), compares the numeric information T2a of memory usage with the numeric information T4c on the minimum memory threshold value (step S1003), reads an identifier of the unloaded program information T5 stacked in the highest position if the memory usage becomes less than the minimum memory threshold value (memory usage<minimum memory threshold value) (step S1004), and determines to load a corresponding control program (a control program having a shortest elapsed time since unloading). Meanwhile, in the first step S1003, if the memory usage becomes equal to or greater than the minimum memory threshold value (memory usage≧minimum memory threshold value), the computer 10 ends the processes of the present flowchart instead of determining a loading process to be performed by the determining unit 105. In addition, if the unloaded program information T5 does not exist in step S1004, the computer 10 also ends the processes of the present flowchart. In addition, when the determining unit 105 reads the identifier stacked in the highest position, a stack pointer moves.

Next, the loading unit 106 performs loading of a control program determined to be loaded by the determining unit 105 (step S1005). Next, returning to step S1003, until the memory usage becomes equal to or greater than the minimum memory threshold value (memory usage≧minimum memory threshold value), the computer 10 repeats the aforementioned processes (steps S1003 to S1005), thereby ending the processes of the present flowchart.

Although it has been described that the control program satisfying the condition of “memory usage<minimum memory threshold value” is loaded, but a control program satisfying the condition of “memory usage≦minimum memory threshold value” may be unloaded.

Through the aforementioned processes, the unloaded control program can be reloaded when the memory usage of the main memory is available, thereby improving usage efficiency of the main memory. Further, when a user reconnects a device to the computer, a probability that a corresponding control program is stored in the main memory increases, and thus a loading time required for starting to use the device can be saved.

Next, the process to be performed when a control program of a device connected to the computer 10 is unloaded by the unloading unit 107 will be described.

When the device detecting unit 109 detects that the printer 20, the mouse 30, the flash memory card 40, or the wireless-module card 50 is connected to the computer 10, and thus loads a control program thereof, the computer 10 calculates a sum of a memory usage and a amount of data of a control program to be loaded at that moment. Then, according to the calculation result, the computer 10 unloads a control program having a longest elapsed time by using the elapsed time information T1, and loads a desired control program.

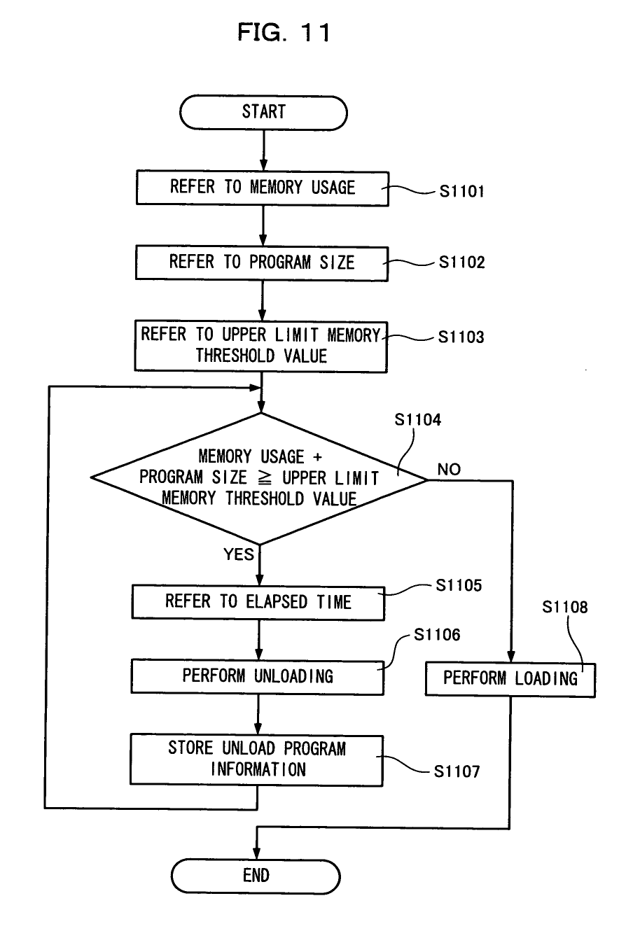

The computer 10 may carry out processes shown in the flowchart of FIG. 11.

When a device connected to the computer 10 is detected by the device detecting unit 109, the computer 10 performs steps in the flowchart of FIG. 11.

When a control program of a device of which connection is detected by the device detecting unit 109 is unloaded by the unload unit 107, the determining unit 105 firstly refers to the numeric information T2a of memory usage from the memory usage information T2 (step S1101), refers to the numeric information T6a on an amount of data of the control program (hereinafter referred to as program size) of the connected device (step S1102), and refers to the numeric information T4b on the maximum memory threshold value from the threshold value information T4 (step S1103). In addition, a control program unloaded by the unloading unit 107 may be stored in a memory area of other memories except for the main memory, and thus the computer 10 can refer to the numeric information T6a on the program size.

Next, the determining unit 105 compares the sum of the numeric information T2a on memory usage and the numeric information T6a on the program size with the numeric information T4b of the maximum memory threshold value (step S1104). In addition, if the sum of the memory usage and the program size is equal to or greater than the maximum memory threshold value ((memory usage+program size)≧maximum memory threshold value), the determining unit 105 refers to the elapsed time information T1 (step S1105) and determines to unload a control program of a device of which the numeric information T1b of elapsed time is the greatest. Meanwhile, if the sum of the memory usage and the program size becomes less than the maximum memory threshold value ((memory usage T9a+program size T12a)<maximum memory threshold value T6b), the determining unit 105 determines to load a control program of a device connected to the computer 10, and the loading unit 106 performs loading of a control program determined to be loaded by the determining unit 105 (step S1108), thereby ending the processes of the present flowchart.

Next, the unload unit 107 performs unloading of the control program determined to be unloaded by the determining unit 105 (step S1106). When the unloading of the control program is performed, the unloaded program information storing unit 108 stacks the identifier of the control program into a specific memory area of the main memory 101 (step S1107).

Next, returning to step S1104, until the sum of the memory usage and the program size becomes less than the maximum memory threshold value ((memory usage+program size)<maximum memory threshold value), the computer 10 repeats the aforementioned processes (steps S1104 to S1107).

If the sum of the memory usage and the program size becomes less than the maximum memory threshold value ((memory usage+program size)<maximum memory threshold value), the determining unit 105 determines to load a control program of a device reconnected to the computer 10, and the loading unit 106 performs loading of a control program determined to be loaded by the determining unit 105 (step S1108), and then the computer 10 ends the processes of the present flowchart.

Through the aforementioned processes, when a device to be used is connected to the computer, a problem, in which the device cannot be used because a control program thereof is unloadable due to a restriction of the memory usage of the main memory, can be avoided. In other words, a control program having a longest unused time among control programs loaded in the main memory (a control program having a least probability to be used later) is automatically unloaded, and thus a desired control program can be loaded instead thereof.

Accordingly, in a control terminal of the present invention, since a control program of a less frequently used device is unloaded, a memory area of a main memory becomes available, and thus it can be effectively used in a computer system in which a device can be separated while the computer system operates. In particular, the control terminal is inclined to be connected with more devices, and is useful in a customized computer system such as a portable terminal device in which a main memory capacity is restricted due to cost.

What is claimed is:

1. A control terminal comprising a connector connectable with at least one peripheral device and a main memory for storing therein a control program for the peripheral device connected to the connector, the control program stored in the main memory being used to control the peripheral device, wherein
the control terminal further comprises:
an unused time measuring unit for measuring an unused time of each control program stored in the main memory;
a data amount measuring unit for measuring an amount of data stored in the main memory;
a threshold value setting unit for setting a threshold value for the unused times of the control programs and a threshold value for the amount of data stored in the main memory;
a determining unit for determining one of a control program to be loaded in the main memory and a control program to be unloaded from the main memory, according to a result of comparison between one of the unused time measured by the unused time measuring unit and the amount of data measured by the data amount measuring unit and the corresponding threshold value set by the threshold value setting unit;
a loading unit for loading the control program to the main memory according to the determination result of the determining unit; and
an unloading unit for unloading the control program from the main memory according to the determination result of the determining unit.

2. The control terminal according to claim 1, wherein the determining unit compares the unused time measured by the unused time measuring unit with the threshold value for the unused time set by the threshold value setting unit, and determines to unload one of a control program having an unused time not less than the threshold value and a control program having an unused time greater than the threshold value.

3. The control terminal according to claim 2, wherein the determining unit determines the control program to be unloaded, based on the comparison between the unused time and the threshold value, for each predetermined monitoring time interval.

4. The control terminal according to claim 2, further comprising a device detecting unit for detecting a state of connection of the peripheral device, wherein when the device detecting unit detects that a peripheral device controlled by using one of the control program having an unused time not less than the threshold value and the control program having an unused time greater than the threshold value is connected with the connector, the determining unit does not determine to unload the used control program, whereas when the device detecting unit detects that the peripheral device is disconnected from the connector, the determining unit determines to unload the used program.

5. The control terminal according to claim 4, wherein
the threshold setting unit sets an upper limit value as a threshold value for the amount of data stored in the main memory, and
when the control program of a peripheral device of which connection is detected by the detecting unit is unloaded by the unloading unit, the determining unit compares the amount of data, which is obtained by adding a amount of data of the control program of the peripheral device to an amount of data measured by the data amount measuring unit, with the upper limit value determined by the threshold value setting unit, and repeatedly determines to unload a control program having a longest unused time measured by the unused time measuring unit until the sum of the amount of data becomes not greater than the upper limit value or until the sum of the amount of data becomes less than the upper limit value, and if the sum of the amount of data becomes not greater than the upper limit value or if the sum of the amount of data becomes less than the upper limit value, the determining unit determines to load the control program of the peripheral device of which connection is detected.

6. The control terminal according to claim 1, wherein
the threshold setting unit sets an upper limit value as a threshold value for the amount of data stored in the main memory, and
the determining unit compares the amount of data measured by the data amount measuring unit with the upper limit value determined by the threshold value setting unit, and repeatedly determines to unload the control program having a longest unused time measured by the unused time measuring unit until the amount of data becomes not greater than the upper limit value or until the sum of the amount of data becomes less than the upper limit value.

7. The control terminal according to claim 6, wherein the determining unit determines to unload the control program by comparing the amount of data with the upper limit value, for each predetermined monitoring time interval.

8. The control terminal according to claim 6, further comprising a device detecting unit for detecting connection of the peripheral devices, wherein
when the control program of a peripheral device of which connection is detected by the detecting unit is unloaded by the unloading unit, the determining unit compares the amount of data, which is obtained by adding a amount of data of the control program of the peripheral device to an amount of data measured by the data amount measuring unit, with the upper limit value determined by the threshold value setting unit, and repeatedly determines to unload a control program having a longest unused time measured by the unused time measuring unit until the sum of the amount of data becomes not greater than the upper limit value or until the sum of the amount of data becomes less than the upper limit value, and if the sum of the amount of data becomes not greater than the upper limit value or if the sum of the amount of data becomes less than the upper limit value, the determining unit determines to load the control program of the peripheral device of which connection is detected.

9. The control terminal according to claim 1, further comprising an unloaded program information storing unit for storing therein identification information on the control program unloaded by the unloading unit in a prescribed memory area, so that a last unloaded control program can be determined, wherein
the threshold setting unit sets a lower limit value as a threshold value for the amount of data stored in the main memory, and
the determining unit compares the amount of data measured by the data amount measuring unit and the lower limit value determined by the threshold value setting unit, and repeatedly determines to load the last unloaded control program based on the information stored in the unloaded program information storing unit until the amount of data becomes not less than the lower limit value or until the amount of data becomes greater than the lower limit value.

10. The control terminal according to claim 9, wherein the determining unit determines the control program to be loaded, for each predetermined monitoring time interval, based on the comparison between the amount of data and the lower limit value.
